(19) United States
(12) Patent Application Publication
(10) Pub. No.: US 2016/0356329 A1
(43) Pub. Date: Dec. 8, 2016

(54) INTEGRATED TORQUE PLATE AND BRAKE CARRIER

(71) Applicant: WABCO Europe BVBA, Brussels (BE)

(72) Inventors: Thomas Corcoran, Leonard, MI (US); Rob Carmichael, Ortonville, MI (US); Markus Stafflinger, Bensheim (DE)

(73) Assignee: WABCO Europe BVBA

(21) Appl. No.: 14/731,039

(22) Filed: Jun. 4, 2015

(51) Int. Cl. F16D 65/00; F16D 55/225

(52) U.S. Cl. CPC F16D 65/0056; F16D 55/225; F16D 65/0068; F16D 2055/0008

(57) ABSTRACT

A disc brake assembly includes a brake support unitarily formed from a brake carrier and an adapter portion 12. The adapter portion 12 has two lateral plates with several mounting bores on a circumference of a mounting circle. The brake carrier has a first tie bar connecting the two lateral plates and extending above the mounting circle. Two radially protruding first support stubs are formed on the two lateral plates at opposite lateral ends of the first tie bar for limiting the travel of a brake caliper. Two first guide structures for an inboard brake spreader plate are located at the opposite lateral ends of the first tie bar between the support stubs. Two guide bores laterally adjacent the support stubs are present for guide pins of the brake caliper.

### TECHNICAL FIELD

The present application relates to a disc brake support and to a disc brake assembly including the disc brake support, a brake calliper, a brake disc and at least one brake pad. The invention relates specifically to a disc brake support and a disc brake assembly for commercial vehicles configured for attaching drum brakes to axle heads.

### BACKGROUND

In commercial vehicles, a pneumatic drum brake is usually attached to a flanged axle head having a plurality of axial through-bores that are typically arranged on a virtual circle. A drum brake is fastened to the flanged axle head via threaded bolts extending through holes in the drum brake support and through the axial through-bores.

It is known to replace the drum brakes with disc brakes by utilizing adapters that, on the one hand, have holes for fastening a brake carrier of the disc brake to the adapter. The brake carrier in turn has corresponding to the through-bores of the flanged axle head and, on the other hand, have a pair of further holes matching the guide pins of the disc brake carrier that is part of the disc brake assembly intended to take the place of the original drum brake.

It is further known to form a disc brake support unitarily encompassing a brake carrier and a drum brake adapter so that the brake support of the disc brake includes the holes matching the through-bores of the axle head. In order to allow for a replacement of the brake pads without requiring the removal of the brake calliper, spatial constraints apply to the shape of the brake support, for example to the extent that the brake support should not impede the access to the brake pads through the calliper. This demand reduces the available structural support by the brake support for the disc brake.

### SUMMARY

Therefore, it is an object of the present application to provide disc brake assembly having a disc brake support unitarily formed by a brake carrier and a drum brake adapter that provides increased structural support by the disc brake carrier and still allows easy installation of the disc brake assembly and easy replacement of the brake pads.

According to the present application, this objective is achieved by a disc brake support comprising an adapter portion and a brake carrier unitarily formed with the adapter portion. The adapter portion has two lateral plates extending parallel to a brake disc plane. Each lateral plate has a flange portion with several mounting bores. All of the several mounting bores of the flange portions have bore centers located on a circumference of a mounting circle with a circle center coinciding with a central brake disc axis and are adapted for affixing the disc brake carrier to an axle brake flange. The brake carrier has a first tie bar connecting the two lateral plates and extending above the circumference of the mounting circle. For limiting the travel of a brake caliper, two radially protruding first support stubs are formed above the two lateral plates at opposite lateral ends of the first tie bar. Further, two first guide structures for an inboard brake spreader plate are formed at the opposite lateral ends of the first tie bar between the support stubs. Two guide bores laterally are placed adjacent the support stubs opposite the guide structures for guide pins of the brake caliper. This space-saving arrangement connects the two lateral plates via the top tie bar extending above the virtual mounting circle, thereby allowing an installation of the disc brake support in a radial movement before and after installation of the brake disc.

The first tie bar may have a mid-portion with a first axial dimension and a first radial dimension, the first axial dimension being greater than the first radial dimension.

The disc brake support may further comprise two bridge arms extending from the two lateral plates toward a second tie bar extending parallel to the first tie bar and to the two lateral plates. In a similar manner as the first tie bar, the second tie bar may have a mid-portion with a second axial dimension and a second radial dimension, the second axial dimension being greater than the second radial dimension. The second tie bar and the bridge arms provide additional structural stability without impeding the replacement of the brake pads because the bridge arms provide for an access opening between the tie bars.

Preferably, no other laterally extending elements connect the two lateral plates to each other, only the first tie bar and the second tie bar. Thus, the flange areas of the disc brake support can be separated by a gap in a circumferential area opposite the first tie bar, i.e., below the mounting circle. This arrangement reduces weight and leaves an opening between the lower portions of the lateral plates for radial installation of the disc brake support.

The second tie bar may include two second guide structures configured for guiding an outboard brake pad. Furthermore, two radially protruding second support stubs may be formed at opposite lateral ends of the second tie bar for supporting a brake caliper. forming these guide and support structures unitarily on the brake support reduces the number of parts necessary for assembling and mounting the disc brake assembly on the axle head.

For ease of installation before the disc brake support is bolted to the axle brake flange, at least one support stub may axially protrude from at least one of the two lateral plates with a circumferentially extending support surface adapted to rest on a circumference of the axle brake flange.

The two flange portions of the lateral plates may include an equal number of the bores. The exact number, however, may depend on the axle brake flange, on which the brake support is mounted.

For reducing weight, a partial circumference of the mounting circle adjacent the first tie bar between the flange portions may be free of material and free of mounting bores. Especially in the presence of the second tie bar, the material can be omitted without compromising structural integrity.

In the assembled state of a disc brake assembly including the disc brake support, the two bridge arms formed on the disc brake support preferably extend underneath the brake caliper and are spaced apart by a distance that is greater than a lateral width of the brake caliper. This arrangement reduces the space requirements above the brake disc.

The brake caliper preferably has a top window that has an axial dimension greater than an axial space defined by axially outer dimensions of the first tie bar and the second tie bar. This width facilitates a replacement of the brake pads without requiring a removal of the brake caliper or a disassembly of the disc brake assembly.

In the following, various aspects and further details and benefits of the disclosed disc brake support and disc brake assembly will be described in more detail with reference to the attached drawings. The drawings are provided purely for illustrative purposes and are not intended to limit the scope of the present invention.

### BRIEF DESCRIPTION OF THE DRAWINGS

In the drawings,

FIG. 1 is a first perspective view of a brake support in accordance with a preferred embodiment of the invention;

FIG. 2 is a second perspective view of the brake support of FIG. 1;

FIG. 3 is a third perspective view of the brake support of FIG. 1;

FIG. 4 is a side view of the brake support of FIG. 1;

FIG. 5 is a top view on a disc brake assembly including the brake support of FIG. 1; and

FIG. 6 is a perspective view of the disc brake assembly of FIG. 5

A different embodiment of the brake support according to the invention, in the assembled state, assembled to an axle assembly.

### DETAILED DESCRIPTION OF THE DRAWINGS

In the following, the term “inboard” describes an axial side or direction with respect to a brake disc toward the interior of the vehicle that also coincides with the side, on which an actuating piston of the disc brake is located in a brake calliper. Conversely, the term “outboard” is used for an axial side or direction toward the outside of the vehicle, i.e., toward the vehicle wheel that is decelerated by the brake disc.

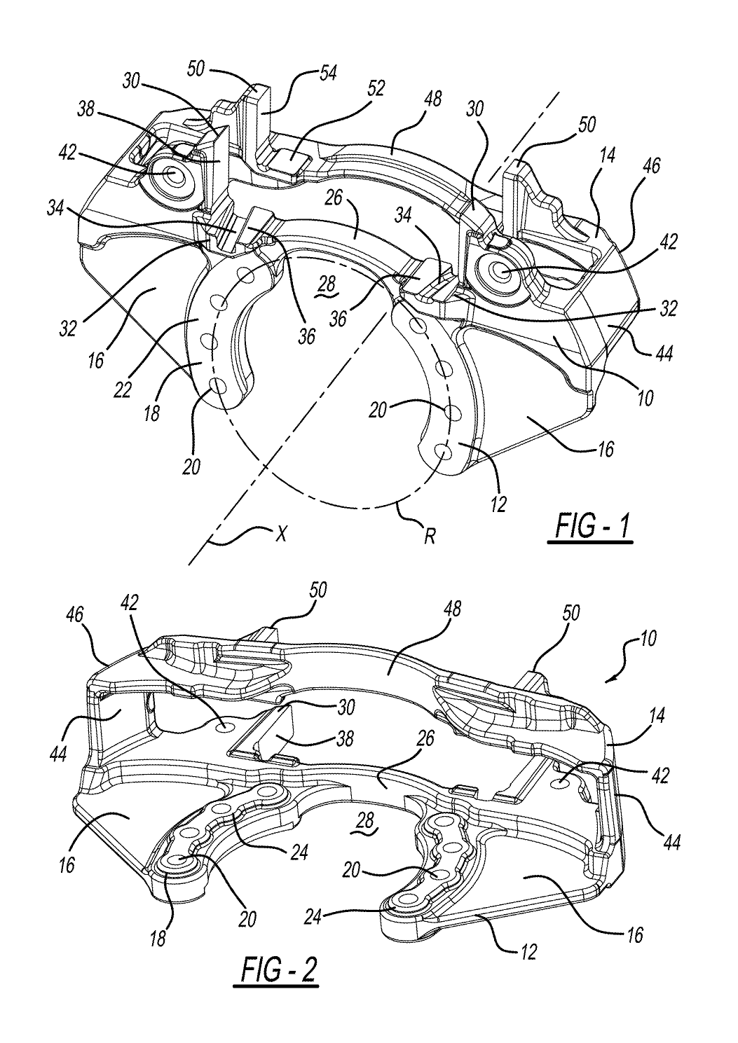

Now referring to FIGS. 1 through 4, a disc brake support 10 is shown in various perspectives. The disc brake support 10 includes an adapter portion 12 and a brake carrier 14 unitarily formed with the adapter portion 12, for example by a die-casting process. The adapter portion 12 and the brake carrier 14 thus form a single monolithic structure. In the following, the brake carrier 14 is defined as being located above the adapter portion 12 so that top and bottom of the disc brake assembly 1 are defined in relative terms by the shape of the disc brake support 10. The terminology is thus independent of a final orientation of the disc brake assembly 1 after installation.

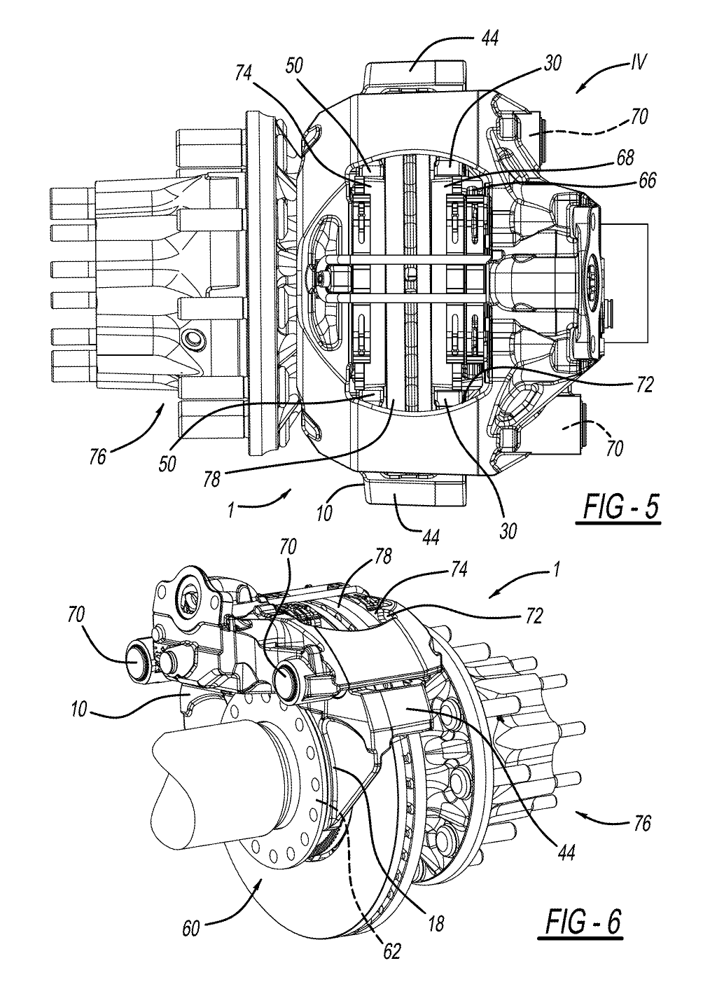

The adapter portion 12 includes two lateral plates 16 extending on opposite lateral sides of a central axis X axis in a radial plane. A flange portion 18 is formed respectively along a radially inner edge of each lateral plate. Each of the two flange portions 18 is at least locally thickened relative to radially farther outward portions of the lateral plate and includes a plurality of mounting bores 20. In this context, the term “bore” encompasses any cylindrical through-holes, regardless of the manner of their manufacture. Thus, for example, the mounting bores 20 may be formed by the casting process or machined without leaving the scope of the present invention. The mounting bores 20 are all arranged at the same distance from the central axis X on a virtual mounting circle R. The radius of the mounting circle R and the number of mounting bores 20 are determined by the configuration of an axle head 60, on which the brake support 10 is being installed. While FIGS. 1-3 only show the disc brake support 10, the other elements of the disc brake assembly 1 are shown in FIGS. 5 and 6.

FIG. 1 shows the inboard side of the adapter portion 12, where the flange portions 18 have a planar flange surface 22 for attachment to an axle brake flange 62 of the axle head 60. FIG. 2 shows the outboard side of the adapter portion 12, where the flange portion 18 includes an axially protruding reinforcement 24 surrounding all of the mounting bores 20. The radially outer areas of the lateral plates 16 are axially recessed from the flange portions 18 on the inboard side and on the outboard side.

The brake carrier 14 is arranged above the adapter portion 12. The brake carrier 14 includes a first tie bar 26 extending laterally above the adapter portion 12 outside the mounting circle R. The first tie bar 26 is curved along an arc generally parallel to the mounting circle R so as to leave a top angular portion 28 of the mounting circle R free of material.

At the lateral opposite ends of the first tie bar 26, laterally projecting first protrusions 30 are formed above the lateral plates 16. The first protrusions are shaped to slidingly engage the inside of a floating brake calliper 64 thereby limiting the axial displacement of the brake calliper 64 in the outboard direction during actuation of the brake.

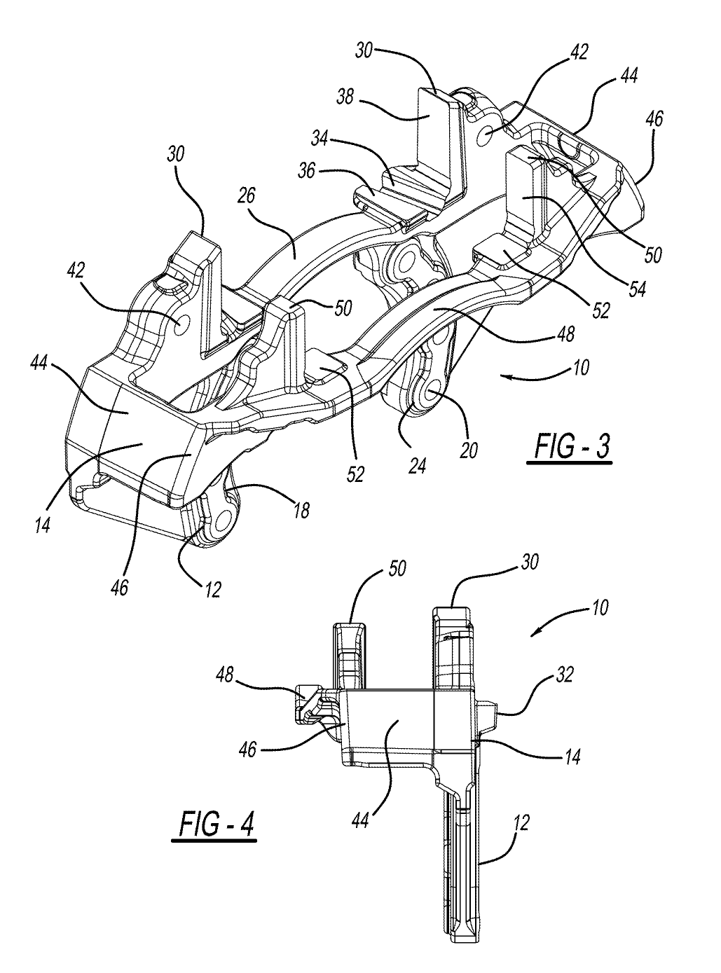

Between the first tie bar 26 and the two radial first protrusions 30, two axial support stubs 32 are provided on the inboard side of the brake carrier 14. On the support stubs 32, guide grooves 34 for guiding a spreader plate 66 are formed. Horizontal guide surfaces 36 for the inboard brake pad 68 are provided adjacent the guide grooves 34. Furthermore, the first protrusions 30 include vertical guide surfaces 38 facing each other for laterally positioning the inboard brake pad 68. The horizontal and vertical guide surfaces 36 and 38 are best visible in FIGS. 1 and 3.

The support stubs 32 serve a further purpose of positioning the disc brake support 10 on the axle brake flange 62 for proper installation. On their radially inward sides, the support stubs 32 are bordered by support surfaces 40 that are adapted to the circumference of the axle brake flange 62. Thus, the support surfaces 40 may be curved in an arc complementary to the outside circumference of the axle brake flange 62. Alternatively, the support surfaces 40 may be planar and extend tangentially to the outside circumference of the axle brake flange 62.

Laterally outside of the protrusions, two guide bores 42 are formed on the brake carrier 14. The guide bores 42 are aligned with corresponding guide bores on the brake calliper 64. In the assembled state, axial guide pins 70 extend through the inboard side of the brake carrier 14 and through the inboard side of the brake calliper 64 for guiding the movement of the floating brake calliper 64 during actuation.

On both lateral sides of the brake carrier 14, a pair of axially extending bridge arms 44 extend toward the outboard side of the disc brake support 10. At their outboard ends 46, the bridge arms 44 are connected via a second tie bar 48 that generally extends parallel to the first tie bar 26. The second tie bar 48 extends axially beyond the outboard ends 46 of the bridge arms 44 as shown in FIG. 4.

A pair of second radial protrusions 50 extend upward at opposite lateral ends of the second tie bar 48 for supporting the brake calliper 64. Between the second radial protrusions 50, horizontal guide surfaces 52 and vertical guide surfaces 54 are formed for guiding the outboard brake pad. As evident from FIG. 4, the second radial protrusions 50 have a smaller height and axial thickness than the first radial protrusions 30.

The first tie bar 26 and the second tie bar 48 form the only connections between the two lateral sides of the disc brake support 10. This allows for a large opening between the lower ends of the flange portions 18 that allows for a relatively easy radial installation of the disc brake assembly 1.

The bridge arms 44 have a smaller dimension in the radial direction than in the circumferential direction. Thus the bridge arms 44 provide structural integrity without requiring much radial space. Generally, as the disc brake assembly 1 is intended to replace a drum brake, the spatial conditions around the axle head 60 are dimensioned for a drum brake, which is generally circular. Thus, the radial dimensions of the disc brake assembly 1 are critical. This, the radial thickness of the bridge arms 44 is their smallest dimension. The radial thicknesses of the first tie bar 26 and the second tie bar 48 are also smaller than the axial and the circumferential dimensions.

FIGS. 4 and 5 show the disc brake assembly 1 in the assembled state. The top view shown in FIG. 5 shows that the top of the brake calliper 64 has a window 72 extending axially over the entire axial dimension of the brake carrier 14. The lateral width, i.e., the circumferential dimension, of the window is wider than the inboard brake pad 68, the outboard brake pad 74, and the spreader plate arranged inboard of the inboard brake pad for transmitting the force of the brake piston (not shown). The bridge arms 44 extend laterally outside of the outer periphery of the brake calliper 64. On the outboard side, a vehicle wheel can be mounted to a hub assembly 76 that rotates with the brake disc 78.

FIG. 6 shows the disc brake assembly 1 from the inboard side as indicated by arrow IV in FIG. 5. FIG. 6 illustrates how the support surfaces 40 of the support stubs 32 rest on the axle brake flange 62 of the axle head 60. It is also evident that the central axis X coincides with the axis of rotation of the brake disc 78.

While the above description constitutes the preferred embodiments of the present invention, it will be appreciated that the invention is susceptible to modification, variation and change without departing from the proper scope and fair meaning of the accompanying claims.

What is claimed is:

1. A disc brake support comprising:
an adapter portion having two lateral plates extending parallel to a brake disc plane, each lateral plate having a flange portion with several mounting bores, all of the several mounting bores of the flange portions with bore centers being located on a circumference of a mounting circle with a circle center coinciding with a central brake disc axis and adapted for affixing the disc brake carrier to an axle brake flange; and
a brake carrier formed unitarily with the adapter portion and having
a first tie bar connecting the two lateral plates and extending parallel to and above the circumference of the mounting circle,
two radially protruding first protrusions formed on the two lateral plates at opposite lateral ends of the first tie bar for limiting travel of a brake caliper;
two first guide structures for an inboard brake spreader plate at the opposite lateral ends of the first tie bar between the first protrusions;
two guide bores laterally adjacent the first protrusions opposite the guide structures for guide pins of the brake caliper.

2. The disc brake support of claim 1, wherein the flange areas are separated by a gap in a circumferential area opposite the first tie bar.

3. The disc brake support of claim 1, wherein the first tie bar has a mid-portion with a first axial dimension and a first radial dimension, the first axial dimension being greater than the first radial dimension.

4. The disc brake support of claim 1, further comprising two bridge arms extending from the two lateral plates toward a second tie bar extending parallel to the first tie bar and to the two lateral plates.

5. The disc brake support of claim 4, wherein the second tie bar has a mid-portion with a second axial dimension and a second radial dimension, the second axial dimension being greater than the second radial dimension.

6. The disc brake support of claim 4, wherein the two lateral plates are laterally only connected to each other via the first tie bar and the second tie bar.

7. The disc brake support of claim 4, wherein a partial circumference of the mounting circle adjacent the first tie bar between the flange portions is free of material and free of mounting bores.

8. The disc brake support of claim 4, further comprising two second guide structures formed on the second tie bar, the second guide structures configured for guiding an outboard brake pad.

9. The disc brake support of claim 4, further comprising two radially protruding second protrusions formed at opposite lateral ends of the second tie bar for supporting a brake caliper.

10. The disc brake support of claim 1, further comprising at least one support stub axially protruding from at least one of the two lateral plates with a circumferentially extending support surface adapted to rest on a circumference of the axle brake flange.

11. The disc brake support of claim 1, wherein the two flange portions include an equal number of the bores.

12. A disc brake assembly comprising:
a disc brake support having
an adapter portion having two lateral plates extending parallel to a brake disc plane, each lateral plate having a flange portion with several mounting bores, all of the several mounting bores of the flange portions with bore centers being located on a circumference of a mounting circle with a circle center coinciding with a central brake disc axis and adapted for affixing the disc brake carrier to an axle brake flange; and
a brake carrier formed unitarily with the adapter portion and having
a first tie bar connecting the two lateral plates and extending above the circumference of the mounting circle,
two radially protruding first protrusions formed above the two lateral plates at opposite lateral ends of the first tie bar for limiting travel of a brake caliper;
two first guide structures for an inboard brake spreader plate at the opposite lateral ends of the first tie bar between the first protrusions;
two guide bores laterally adjacent the first protrusions opposite the guide structures for guide pins of the brake caliper;
a brake caliper slidingly supported by the disc brake support; and
a pair of brake pads slidingly guided by the disc brake support.

13. The disc brake assembly of claim 12, further comprising a brake disc extending coaxially with the central brake disc axis coinciding with the circle center of the mounting circle.

14. The disc brake assembly of claim 12, further comprising two bridge arms formed on the disc brake support, the two bridge arms extending from the two lateral plates toward a second tie bar extending parallel to the first tie bar and to the two lateral plates, wherein the two bridge arms extend underneath the brake caliper and are spaced apart by a distance that is greater than a lateral width of the brake caliper.

15. The disc brake assembly of claim 14, wherein the brake caliper has a top window that has an axial dimension greater than an axial space defined by axially outer dimensions of the first tie bar and the second tie bar, and that has a lateral dimension allowing for an insertion and removal of brake pads.

16. The disc brake assembly of claim 14, further comprising a pair of brake pads slidingly guided by the disc brake support 10.
